(19) United States
(12) Patent Application Publication
(10) Pub. No.: US 2009/0240734 A1
(43) Pub. Date: Sep. 24, 2009

(54) System and methods for the creation, review and synchronization of digital media to digital audio data

(76) Inventors: Geoffrey Wayne Lloyd-Jones, Wellington (NZ); Douglas Brian Lloyd-Jones, Sydney (AU)

Correspondence Address: Mr. G.W. Lloyd-Jones CO/ Mr. R. Baitey, 42 Bay Shore Drive, Plymouth, MA, 02360, US

(21) Appl. No.: 12/320,208

(22) Filed: Jan. 21, 2009

Related U.S. Application Data
(60) Provisional application No. 61/023,178, filed on Jan. 24, 2008.

(51) Int. Cl. G06F 7/00; G06F 17/00

(52) U.S. Cl. 707/104.1; 707/E17.101; 707/E17.01

(57) ABSTRACT

The system and its methods includes at least one computer for reading and writing digital files, a local drive for file storage or ability to access network storage, the ability to record and playback digital audio media, a software interface and the software's associated database.

The invention provides a software interface and methods, enabling access to audio files together with indexed storage of audio file digital assets, where digital assets are composed of any form of digital data. The software interface also includes unique methods to assist Users in the synchronization digital assets to audio events where an audio files digital assets are linked to time values relative to the length of the audio file. The software interface also includes unique audio playback methods allowing Users to scan audio data based on an audio files play length and/or play segments of an audio file based on selections made from an audio files' list of digital assets.

This Application Claims Priority from Provisional Patent No. 61023178, filed on 24 Jan. 2008 Title: SYSTEM AND METHODS FOR THE CREATION, REVIEW AND TIME-BASED SYNCHRONIZATION OF AUDIO DATA AND ASSOCIATED MEDIA

### STATEMENT REGARDING FEDERALLY SPONSORED RESEARCH OR DEVELOPMENT

Not Applicable

### REFERENCE TO SEQUENCE LISTING. A TABLE, OR A COMPUTER PROGRAM LISTING COMPACT DISC APPENDIX

Not Applicable

### REFERENCES CITED

| | | |
|---|---|---|
| 6,871,107 Townsend L. et. Al | July 1999 | 700/94 |
| 9,809,869 A Townsend L. et. Al | September 2002 | 707/500.1 |
| 6,938,029 B1 August 2005 Tien A. | August 2005 | 707/1 |

### BACKGROUND

### Digital Asset Storage

Typically, a large percentage of current software is focused on linking audio content to text documents, images and/or video. In such cases the audio file takes the relationship of a digital asset, supporting the primary file, where the primary file is a document, video or image or collection of images. Microsoft products OneNote and PowerPoint software are a good examples of such an approach and do not support adding digital assets to the audio file.

From a different perspective, Dictation Buddy (www.highcriteria.com) stores textual data, where textual input ie. annotation text, is sequentially indexed and stored inside the digital audio file itself Using this approach the digital audio file is clearly the ‘parent’ in this relationship as its digital assets stored with the audio file itself. This method is better suited to storing an audio file digital assets that the Microsoft examples above, but is limited to storing text only and must use a non-compressed PCM (.wav) audio file format.

In yet another form, an audio software product published by FTY Pty. Ltd. have taken the above approach a step further again, by placing sequentially indexed data structures within an audio file that can contain information that points to other digital assets. This method enables the audio file to be linked with or associated with not only text but also images and/or video clips. (eg.FTR Pty Ltd. U.S. Pat. No. 6,871,107 and U.S. Pat. No. 9,809,869). However, this method is also limited to storing text only and again, for this approach to work, it must use a non-compressed PCM (.wav) audio file format.

Some web based systems such as “Project Pad” an opensource project, allow for collaborative internet access and linking of audio file digital assets by assigning unique URL's to files stored on a Server and, then using Client template files (eg. xml documents, RDF metadata or similar structures), store an audio files digital assets such as annotation text or an image, by linking to MP3 flames (a section of the audio file that contains at least a spoken work or phoneme) of streamed audio data. More specifically, Project Pad allows users to attach comments or link images to a frame segment within an MP3 audio file.

This approach, because it indexes to the MP3 flames is currently limited to using MP3 audio file format although it would be possible to move to other formats that use flame data structures similar to the MP3 format.

A system and method of storing digital assets similar the current invention is detailed in the US Pat. No. 6,938,029 issued to T. Allen, and is similar to this invention in that it also uses a database for the storage of an audio files digital assets. This method overcomes all of the above limitations as its application is not limited by audio file type and can store any form of digital media referenced to the audio files time-track index contained withing its database.

Although the database structure in not given, it is explained that the database as used in this invention uses the sequenced time-track indicia generated by the recording device to provide an index for creating new digital asset records or items. Such a method works well with video recording, but without the invention creating its own referential indicia upon which it could create digital asset indexes, the invention would not work with audio files as audio files do not rely on or contain sequential time-track data. Sequenced time-track indicia is usually only generated for media using multiple images in sequence such as video for example.

Additionally, even if the invention U.S. Pat. No. 6,938,029 was modified to create and store pure audio media, pre-recorded audio files from other sources could not be added to such a system without having to play the entire audio file so that the required time-track indicia could be generated.

Unlike previously described audio file asset indexing methods, the present invention provides the means of storing an audio files digital assets by creating new audio asset records using an index based on the calculated playtime of the audio file.

Unlike previously described audio file asset linking or indexing methods, the present invention overcomes the above limitations by not using sequenced time-track indexing but instead uses the calculated playtime of an audio file based on the number of audio file data ‘blocks’ or segments as a base time-line value prior to audio asset synchronization methods being applied.

Unlike previously described audio file asset linking systems the present invention provides the means to storing one digital asset record or a plurality of plurality of digital asset records to a single time-line value where individual digital asset records may contain zero or multiple digital assets.

Audio Asset Synchronization During the recording or playing back of audio media there is always a time difference between the Users' hearing an audio event and the time it takes for the user to add an audio asset such as a text annotation or an image, resulting in a time difference between the Users intentional placement of the Tag and the actual occurrence of the audio event.

The synchronization of an audio asset to the point where the User heard the audio event can usually only be set by stooping the audio playback and restarting the play at an earlier position in the audio files time-line and then Pausing the playback while as audio asset is added or adjusted to a more exacting position of the audio event of interest. Such a method can be very time consuming if a recording is several hours long and has many points where audio assets are required to be added. Further, when recording live events, it is usually not an option to stop the recording process while the User adds annotation text for example, to the recorded files time-line.

On-the-fly synchronization of digital assets to an audio file during the recording or playback processes, has largely been ignored within the software industry. The present invention addresses the foregoing limitations associated with currently existing software interfaces by providing a method to manage and facilitate on-the-fly, User adjustable Mark values (a Mark value representing a time-line value within the audio files time-line), when indexing digital assets to digital audio file content during a recording or playback session.

The present invention provides an interface where the User can negatively adjust a Mark value relative to the audio files current time-line position or stop the time-line count, during a recording or playback session. The present invention also provides the means of using Hotkeys to continue to add digital assets using another Mark value, on occasions where the first Mark value has been set to a fixed value and the a time-line count stopped.

Playback Methods Typically, most audio software interfaces offer methods of moving through digital audio files by either allowing the User to click on and drag a slider control or showing a waveform display where the user can set a new play position by dragging a colored line for example to a new position within the displayed waveform. Additionally, such methods often allow the user to select a start-of-play point and a end-of-play point.

Other products also exist that incorporate annotation functionality and allow the User to move to a point within an digital audio file that has an annotation by clicking on the annotation text itself. Additionally, a product named Dictation Buddy (www.highcriteria.com) provides a method that allows the user to click on a button to jump a fixed amount of time, either forward of backward from the current play position of the audio file. Historically, there may also have existed reel-to-reel audio tape players that could play through a reel of audio tape at preselected intervals however, it is not likely that the reel-to-reel players interface or the methods used, bear any resemblance the current invention.

Audio players today do not provide the functionality or methods to enable a User to automatically scan through an entire audio files content at selected time intervals.

Audio players today do not provide functionality or methods to enable a User to selectively play though a list of an audio files digital assets as determined by a User selecting from a database filtered list of an audio files digital assets.

Audio players today do not provide functionality or methods to enable a User to play a section of audio file determined by selections made from a list of an audio files digital assets. At the current time, no additional references can be cited.

The present invention addresses the foregoing limitations by providing a method and interface enabling a User to sequentially scan through the entire content of an audio file at User selected time intervals and play a section of the audio file for a User selected play period.

The present invention addresses the foregoing limitations by providing a method and interface enabling a User to play though a list of audio assets according to User selected digital asset content and play the audio file for a User selected play period for each audio asset presented in the audio asset list.

The present invention addresses the foregoing limitations by providing a method and interface enabling a user to play a section of audio determined by user selections made from lists of audio assets.

### GLOSSARY

Audio asset: digital media associated with an audio file.
Audio file: A digital file containing digital audio data.
Computer (general): Means an electronic device including memory, electronic interface devices such as keyboard, mouse, keypad or touch screen, sound recording and playback capability either as a hardware device or as a virtual device ie. a sound card emulator, and digital storage or electronic processing capability either as part of the electronic device or available to the electronic device through a network connection.
Digital Asset(s) Any digital media or metadata that has a database relation with, is referenced to or is referentially linked to a digital audio file.
Mark: a numeric value within the range of an audio files time-line
A Mark value may be comprised of either a current audio file time-line value minus a time adjustment value or a fixed or static time-line value minus a time adjustment value.
Metadata: Digital data of any type, that may contain information or is associated with digital medias' content.
Playtime: The total time taken to play an audio files digital content.
Record: When referring to audio data. The process of creating an audio file.
Record: When referring to a database—A defined structure residing within a database, where data is stored.
Soundcard: a hardware or virtual device that provides digital -to-analogue conversion or analogue-to-digital conversion for allowing digital signals to be recorded or played back and allowing analogue signals to be recorded.
Time-line: Represents all available numeric values that form a linear range between 0 and a digital audio files total playtime.
Tag: data comprised of a Mark value relative to the length of the audio file plus some form of digital media content.
User: Person interacting with a computers electronic interface.
User Interface: The software installed and residing within a computer and/or computers memory and displayed on a screen to facilitate User interaction with the software .

### SUMMARY

Several methods exist, enabling computer Users to associate metadata and/or digital assets to audio files. However, these methods either use the audio file itself to store textual data, which means that the methods can only work with particular audio file types to achieve an association between the audio file and its digital assets, or use database structures to store audio/video digital assets reliant on sequenced time-track indicia provided by the source file or as part of an electronic recorder or players functionality, as a means of providing an index for the new digital asset records.

It is the object of this invention is to provide a system and methods for digitally storing audio file digital assets using a database structure to store the audio files digital assets that does not use sequenced time-track indicia but relies on indexing derived from the size of the of the audio file itself.

It is also the object of this invention to provide a system and methods for digitally storing audio file digital assets based on User initiated system events such as a mouse-click or pressing a key on the keyboard, where an audio files digital assets may be any type of digital media such as text, images video etc.

Often when recording or playing back an audio file there is a time difference between a computer Users cognition of an aural event and/or the time required for the User to add appropriate metadata such as annotation text. The time required for a User to add audio metadata is dependent on many variables, a Users typing ability or the rate at which a person is speaking for example. The current invention helps overcome these limitations by allowing the User to adjust the Mark values of digital assets about to be added to the audio file during a recording or playback session, to match the audio file content. It is a further object of this invention to provide a software interface and methods to assist computer Users synchronize their actions to cognized audio events during audio playback or recording sessions when adding audio digital assets.

It is a further object of this invention to provide a software interface and methods to assist the User in accessing and reviewing digital audio file content through methods either, relative to the digital audio files length or relative to any digital assets previously associated with an audio file. The current invention overcomes the existing software limitations where Users have not been provided with an interface or methods that would allow then to systematically review lengthy audio files or select and/or review sections of audio files based on the contents of the audio files digital assets.

### BRIEF DESCRIPTION OF THE DRAWINGS

FIG. 1 is a schematic diagram of a system for using the present inventions software.

FIG. 2—is the database table and relationship design (database schema)

FIG. 3—is a flow chart depicting operation flow, when adding Tags during a playback session

FIG. 4—is a flow chart depicting the operational flow during a recording session

FIG. 5—is a graphic example of digital asset synchronization

FIG. 6—is a screen shot of the Recording and Hotkey interface

FIG. 7—is a screen shot of the Playback interface where digital assets consist of text only.

FIG. 8—is a screen shot of playback interface where digital assets consist of text, audio and images.

FIG. 9—shows graphic examples of each of the playback timing methods.

FIG. 10—is the first part of a two part flow Part A of flow charts depicting operation flow, when using the different playback methods.

FIG. 11—is a flow chart (including pseudo code), depicting operation flow, when using the playback interface FIG. 4 to scan through an audio file and is a continuation of FIG. 10.

FIG. 12—is a flow chart (including pseudo code), depicting operation flow, when using the playback interface FIG. 4 to playback using a selected Tag value. FIG. 12 is a continuation of FIG. 10.

FIG. 13—is a flow chart (including pseudo code), depicting operation flow, when using the playback interface FIG. 4 to playback a section of an audio file where the section is determined by the selection of audio Tag values. FIG. 13 is a continuation of FIG. 10.

### DESCRIPTION

### System

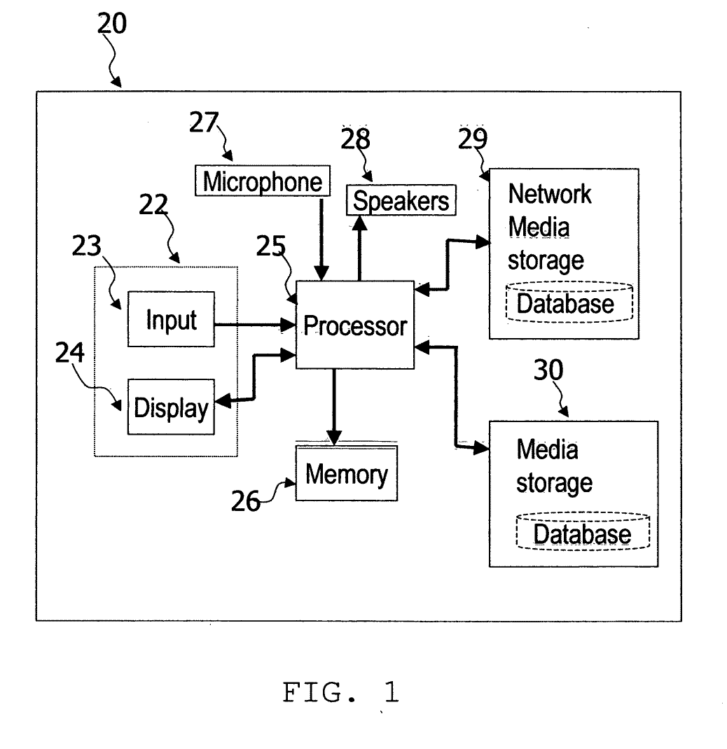

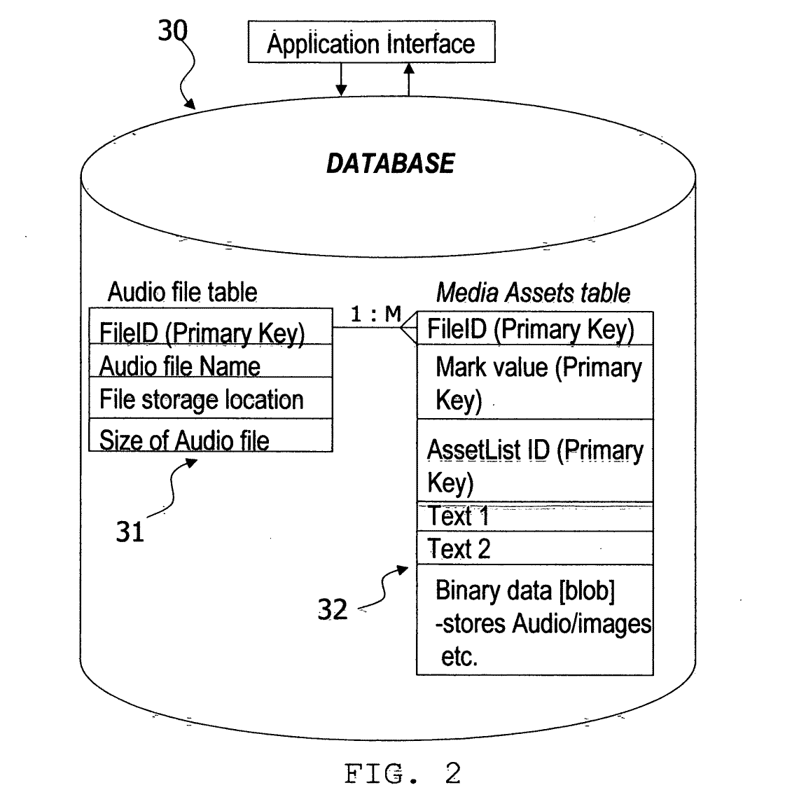

Referring to FIG. 1, there is shown a system 20 for creation and presentation of time based audio data and associated media, according to one illustrative embodiment of the present invention. System 20 includes a User interface 22 including input devices 23 and display 24, a processor 25, memory 26, microphone 27, speakers 28 and media storage 29,30. Memory 26 stores suitable software for creating, accessing and displaying digital media, as is described in more detail below. Input device 23 of user interface 22 may take any suitable form, such as a keyboard, keypad, mouse, or any other input device, or any combination thereof. User interface 22 may also take the form of a display with touch-screen capability.

A User may use the interface to select digital media from a digital storage medium 29,30 or other source or save digital media to a storage medium 29,30 where the digital storage medium may be attached, linked through a network or reside within an electronic device.

The following descriptive embodiment of the present invention is presented in three parts. Firstly, a description of the media storage database structure is given and how the structure is designed to accommodate storage of data pertaining to the method of storing digital assets associated with audio files. An example of adding digital assets, is then described Secondly, a method of synchronizing digital media data to audio file content is presented. An embodiment of the invention is then further described where the synchronization method is applied to a recording situation. Finally methods of Playback are described followed by a description of the application of these methods when applied to one embodiment of the invention.

Database Structure for the storage of audio files associated media. In one embodiment of the present invention two database tables are required. FIG. 2 shows a Database 90 (visually containing the database schema) where the database file is located locally within an electronic device such as a personal computer, PDA, cellular phone or alternatively located on network storage medium.

The “Audio” file table 91 stores data about individual audio files. Audio file records stored in this table are hereafter referred to as Parent files. The “Audio” file table has a one-to-many relationship with the “Media Assets” table 92 where the “Media Assets” table is used to store Mark values and any digital media that may have been added by a User during the recording Parent file or playback sessions of involving the Parent file. The method of using a database table to store media assets (the “Media Asset” table) and linking this information the Parent file, means that one or many media assets of any data type can be directly associated with any single Mark value relative to the Parent file.

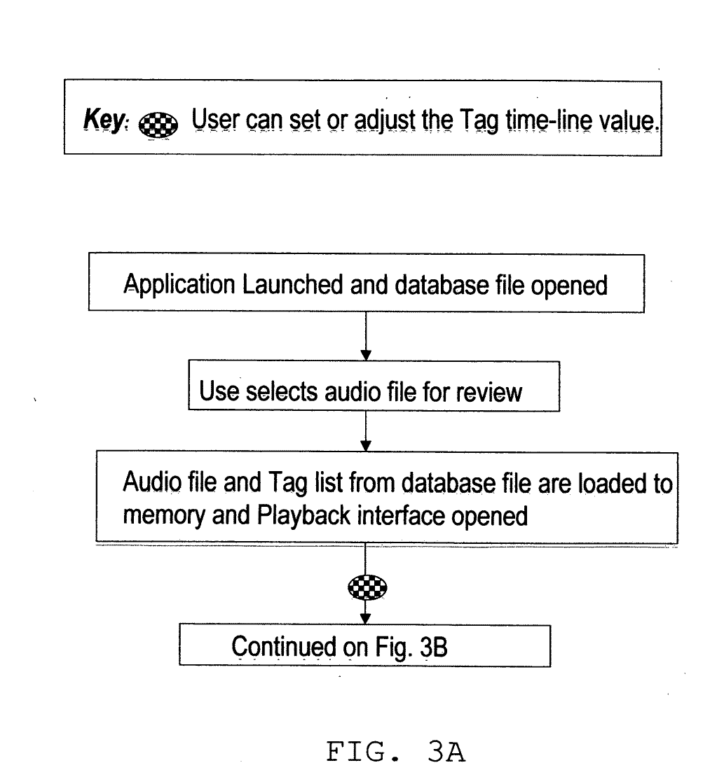

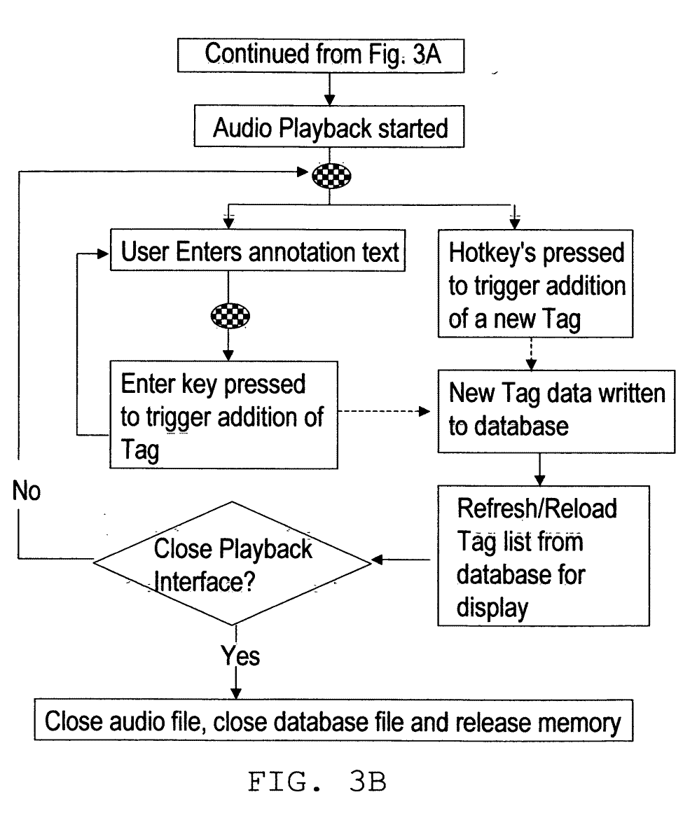

Using the above structure enables Users to add text, images or any form of digital media as digital assets to an existing audio file. The structure is also file type independent, so that any type of audio file may be incorporated into the database either through recording using the current inventions interface or importing audio data from an external source. Additionally, the number of images, voice notes, video available to any single Mark value is limited only by the processing power of the electronic device used and the software interface functionality as provided to a User. In one embodiment of the invention, the present invention is further understood to those skilled in the art, by referring to FIG. 3 showing a flow diagram of system and User events during audio playback creating the addition of new indexed items (Tags) to the database. Tag data in this simplified representation, consisting of Text and a Mark value as calculated according to the Key 33.

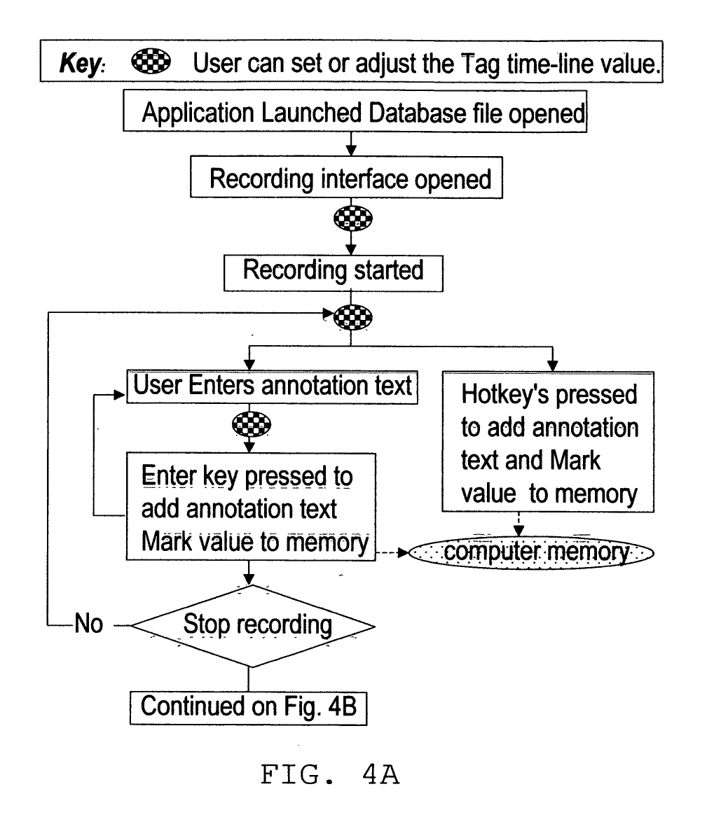

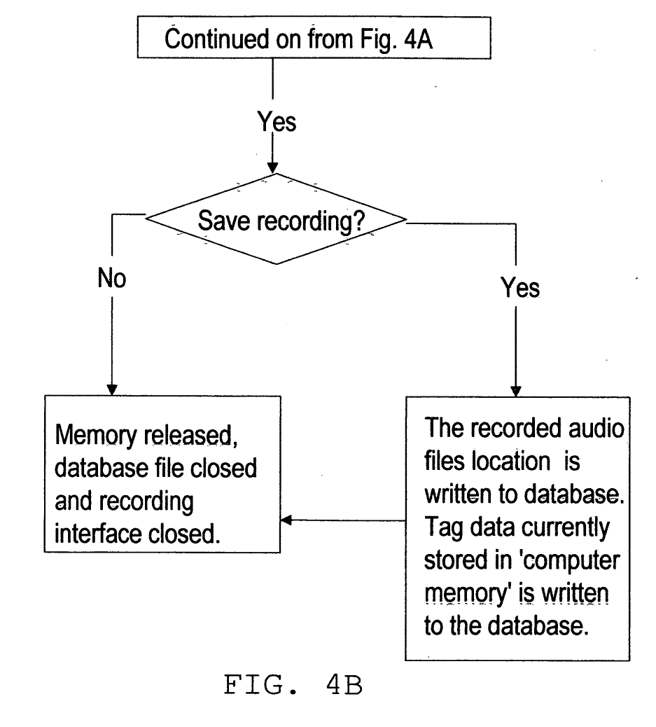

Additionally, in one embodiment of the invention, the present invention is further understood to those skilled in the art, by referring to FIG. 4 where there is shown a flow diagram of system and User events triggering the addition of digital assets to a database during an audio recording session. A precise description of a “Mark” value as used for indexing is given hereafter.

Synchronizing the addition of digital media to an audio files time-line In one embodiment of the invention, a software interface is provided enabling the User to record or playback audio and add time-adjusted indexing to text based input on-the-fly. In this embodiment, the user interface provides a method to assist the User in synchronizing audio events to data input. The synchronization method allows firstly for a negative time-adjustment to be set, where the Mark value linked to the User added text (annotation), about to be associated with an audio file, is adjusted negatively; so that the audio event can better match the time an audio event was heard.

Secondly the method, allows the User to “Hold” or ‘freeze’ the Mark value, giving the User more time to enter additional text to be associated with the audio file at the adjusted fixed Mark value. If the “Hold” has not been triggered and the negative time adjustment is zero, the Mark value of any saved record is equal to the current audio playtime position ie. the length of current audio recording or the current play position relative to the files length if audio is being played back.

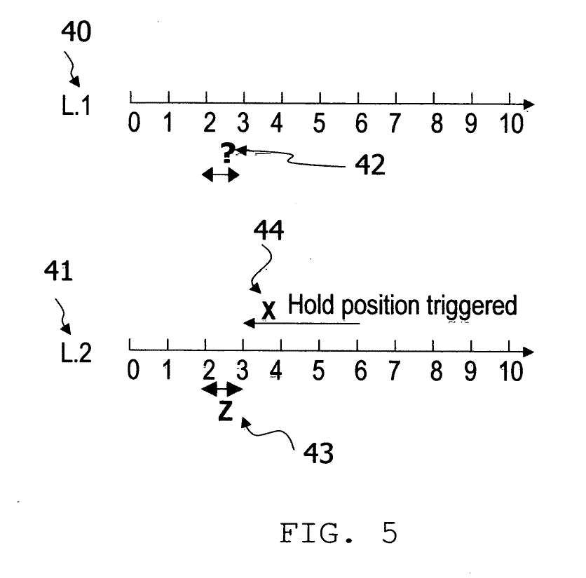

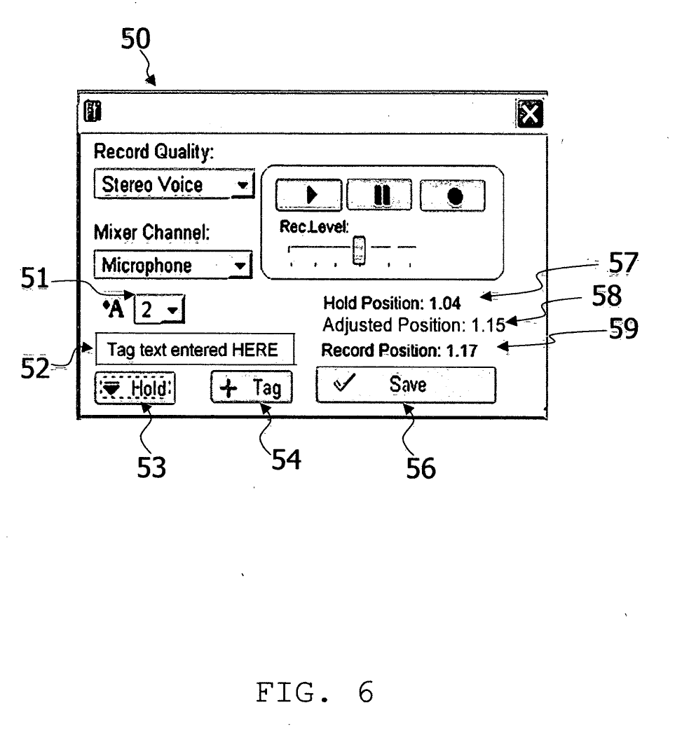

Referring to FIG. 5 Line1 40 represents real time speech events count of 1 audio event per second and Line2 41 represents a users' real time cognition of the audio events of 1 audio event per second. “?” 42 represents the time difference between a speaker's utterance and the users cognition of the utterance. “Z” 43 represents an audio offset value of 1 second at point 3 on the Linr2 41 time-line. “X” 44 (at 2 seconds) represents the Hold point where the Hold point was triggered by a user (Line2 41 time-line)

The resultant Mark value as saved would be 3 secs−1 sec=2 secs. The time-line value remaining fixed until the User stores the new values or deactivates the Hold option. Had the Hold position has not been triggered by the user, the Mark value is equal to the current time-line value minus the audio adjustment value, where the current time-line value is continually increasing as the audio recording or playback process continues.

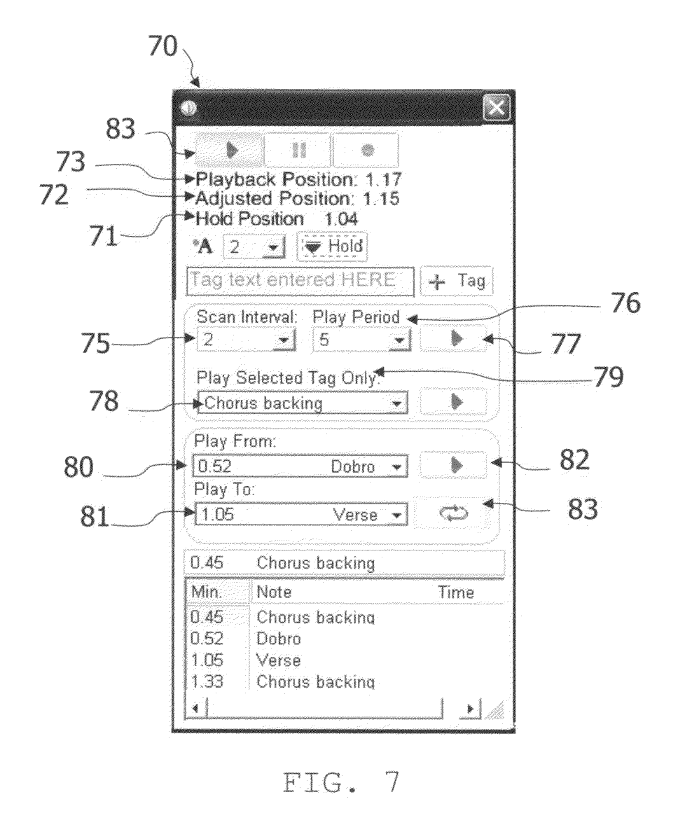

Referring to FIG. 6 a software interface is shown where the audio Mark value can be negatively adjusted using the list box 51, giving the User more time to enter text using the text box 52 as playback proceeds. The Mark values negative adjustment can be set to a value suitable to the users typing skills and, for example the rate or speech being recorded. The time-line values 57, 58, 59 relative to any Mark value being displayed are provided so that the user remains informed as to where exactly Tags will be placed within the audio time-line. In one scenario, the above synchronization methods are used for adding “Tags” containing text where a “Tag” is comprised of a Mark value and some User added text input.

Placement of Mark adjustment functionality on the recording interface gives the user the ability to rapidly change the ‘working’ Mark values, enabling the user to rapidly adapt to environments where the rate of audio information presented and being recorded is changing. For example, where several people are taking turns to speak as is often the case during a business meeting for example.

In cases where a number of references are being cited, during a lecture for example, the Hold button 53 can be used to ‘freeze’ the Mark position, giving the User time to complete lengthy annotation text entries. Additionally, musicians could use Tags for discovery of audio event architecture or sequences for instrumental analysis.

Hotkey data entry FIG. 655, 60 can be used for storing the occurrence certain “phrases” or words used during a court proceeding. The Hotkeys are able to be set by the user 60 and automatically add Tag text without the user having to press the enter key or click on the “+Tag” button 54.

Hotkeys can also be used to add Tags where the Mark value has been fixed and the User needs to add a reference unrelated to the text the user is currently typing in the Tag text box. In this event, the user can add a Tag using the Hotkeys, where the Hotkey entry and a another secondary Mark value will be used that is calculated from the current recording position plus any adjusted value without altering the fixed time Mark value.

In another scenario, the above audio synchronization method could be used for adding Tags for live performance musical events such as the beginning of certain section or event in a musical piece, such as the chorus, the start of a certain instrument or instrumental style or a change in chord.

It is also intended ‘speech recognition technology’ be added to enable the addition of new Tags when a word/phrase is uttered or a particular sound recorded without interfering with a users initiated process when adding new Tags.

Synchronizing the addition of digital assets an audio file when playing audio an audio file.

In one embodiment of the present invention, the synchronization method previously described above is also available when playing back audio files. The only difference when referring to this embodiment of the invention is that during recording, Tags are not added to the database until a recording is saved. See FIG. 4 for description of operational flow when adding Tags during a recording session.

Tags added during playback are immediately added to the database and the users view of Tag list is updated. See FIG. 3 for description of operational flow when adding Tags during an audio playback session.

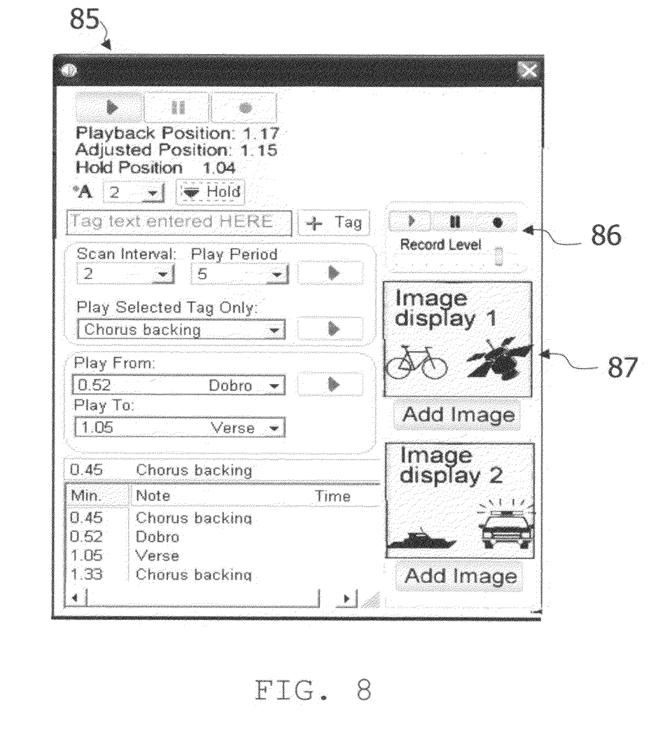

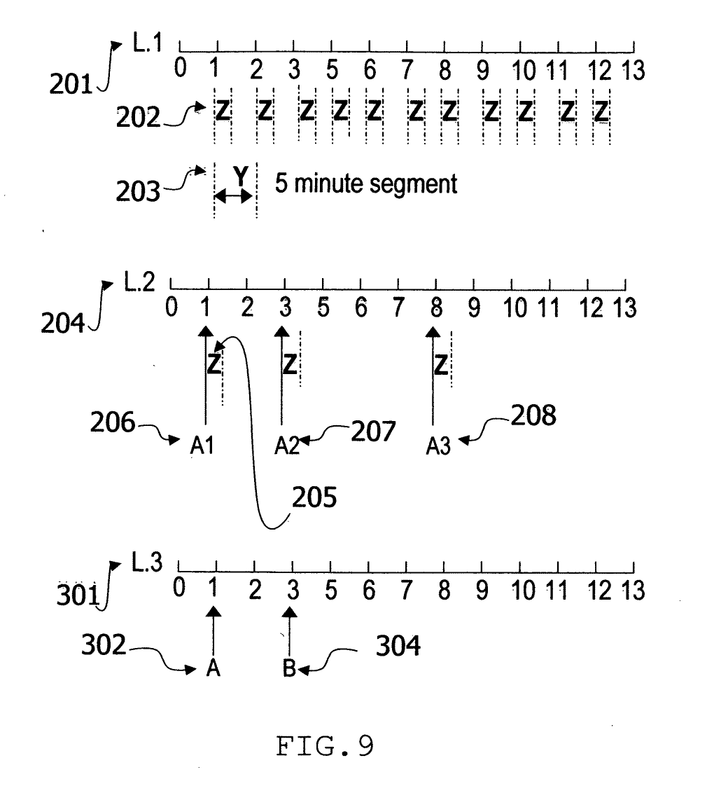

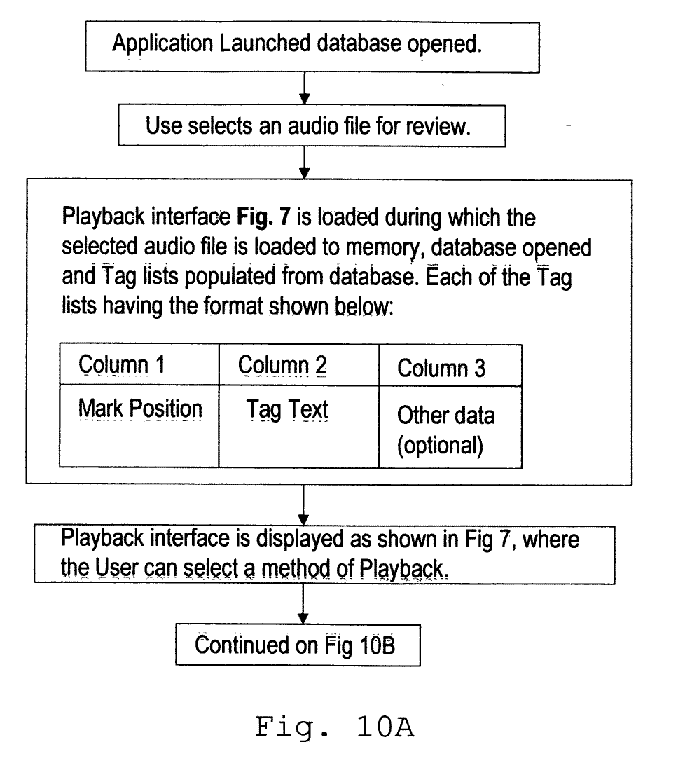

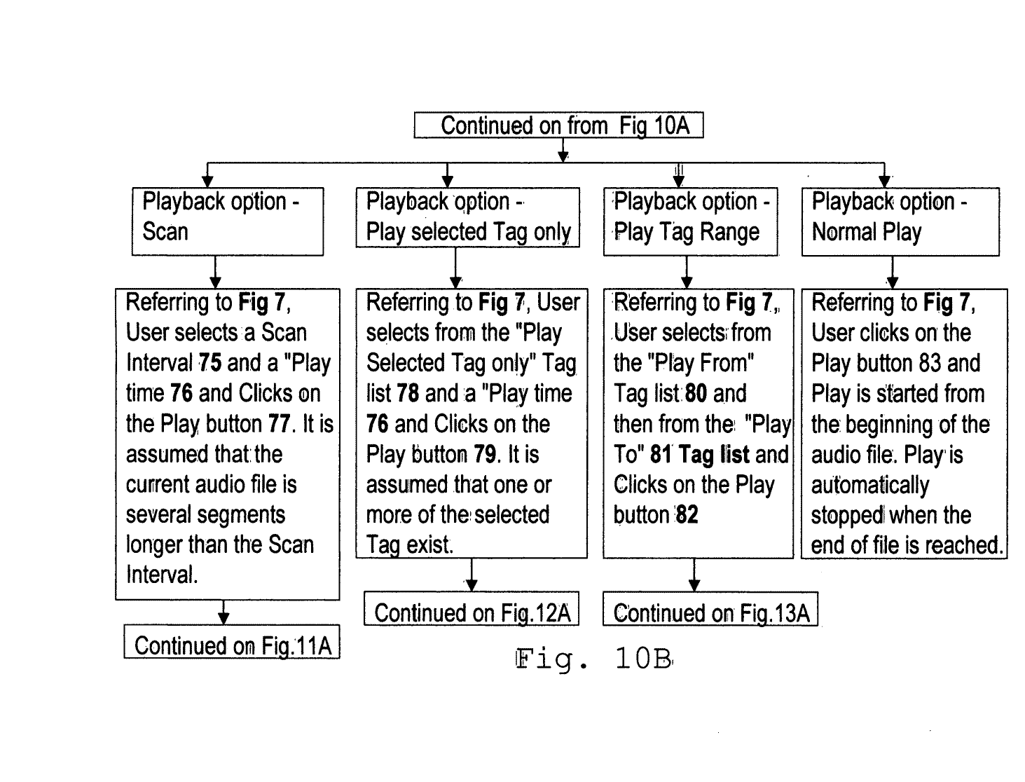

In one scenario the Playback interface FIG. 7 can be to add Tags' using the same methods as applied during a recording session, In another scenario, the playback interface FIG. 7 85 can be used to display an image 86 where a Mark values can be used to calculate a relative date/time value using the date/time at which the audio file was created as a base point and then used to match up with a pictures date/time stamp. Pictures taken during a court proceeding for example could later be added to tie in with an audio recording of the evidence presented. In another scenario the audio file content may be a lecture or seminar. In such cases there are often images displayed as part of the presentation. These images can be added as audio assets and displayed in sync with the audio file playback.

As is detailed hereafter, the database also provides for the addition of multiple media assets to be linked to a single audio Mark value. In one scenario multiple images could be displayed showing different views of an object eg. The planes or facets of a crystal.

In another scenario, in legal cases where there exist multiple interpretations of a previous court ruling, the playback interface FIG. 8 could be used for adding audio notes to a Tag detailing additional interpretations of the court ruling.

Methods of Playback In one embodiment of the present invention audio files can be scanned through at selected intervals. Referring to FIG. 7, a Playback interface 70 is shown where then User can select a time interval (in minutes) 75 and a play period 76 (in seconds). Clicking on the Play button 77 will start audio play, with play continuing for the playback period before moving to the next interval.

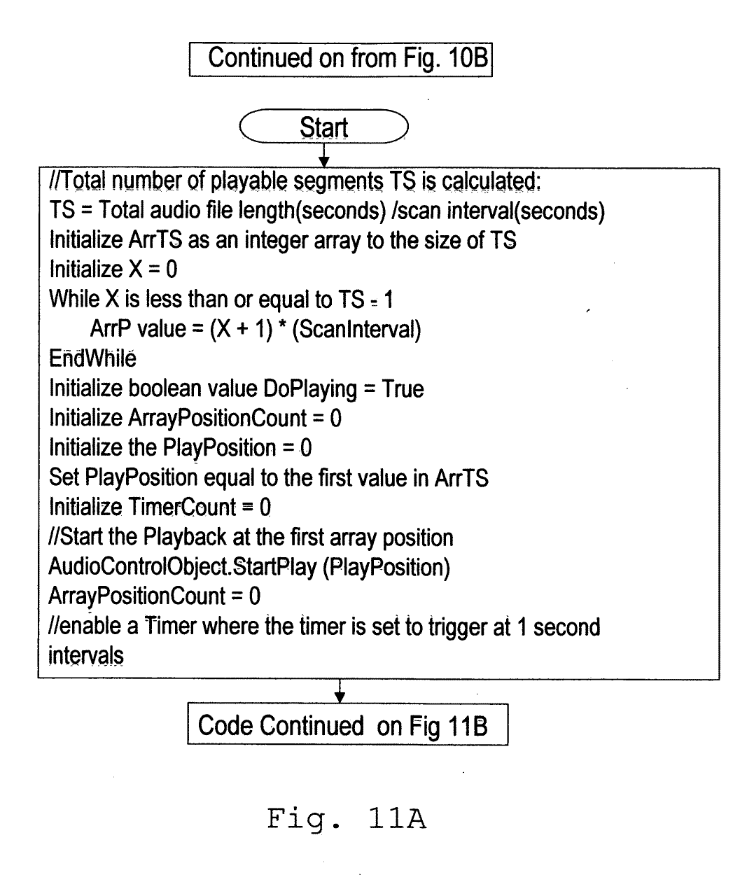

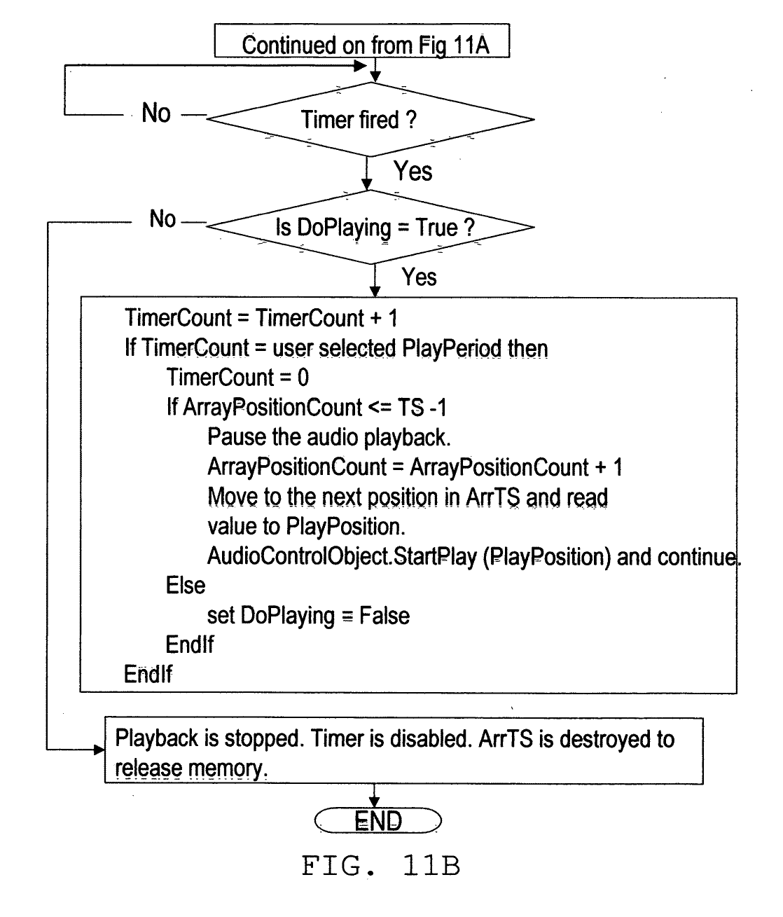

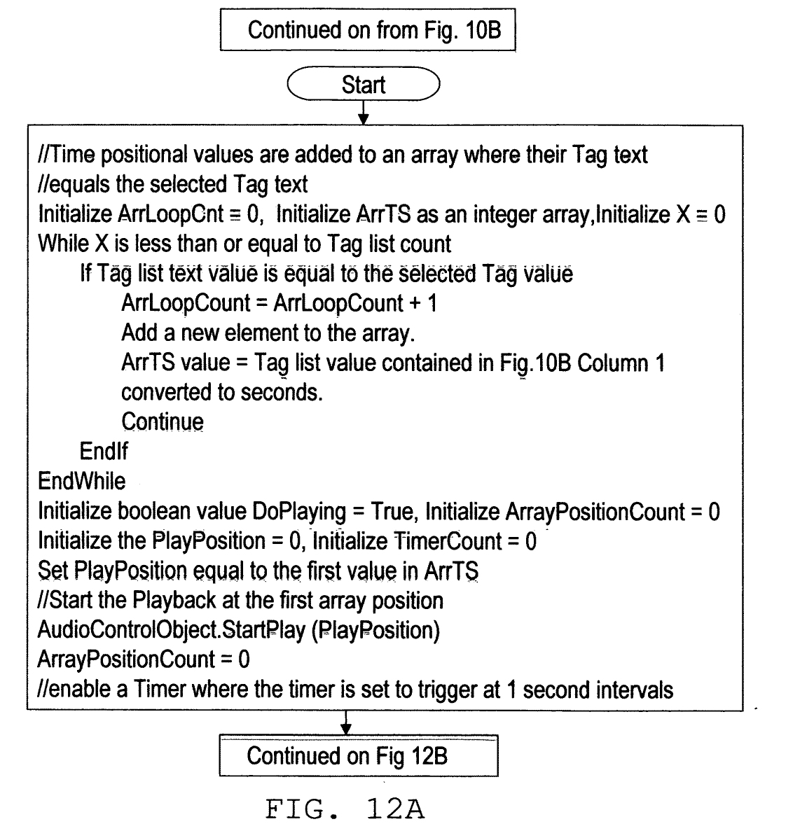

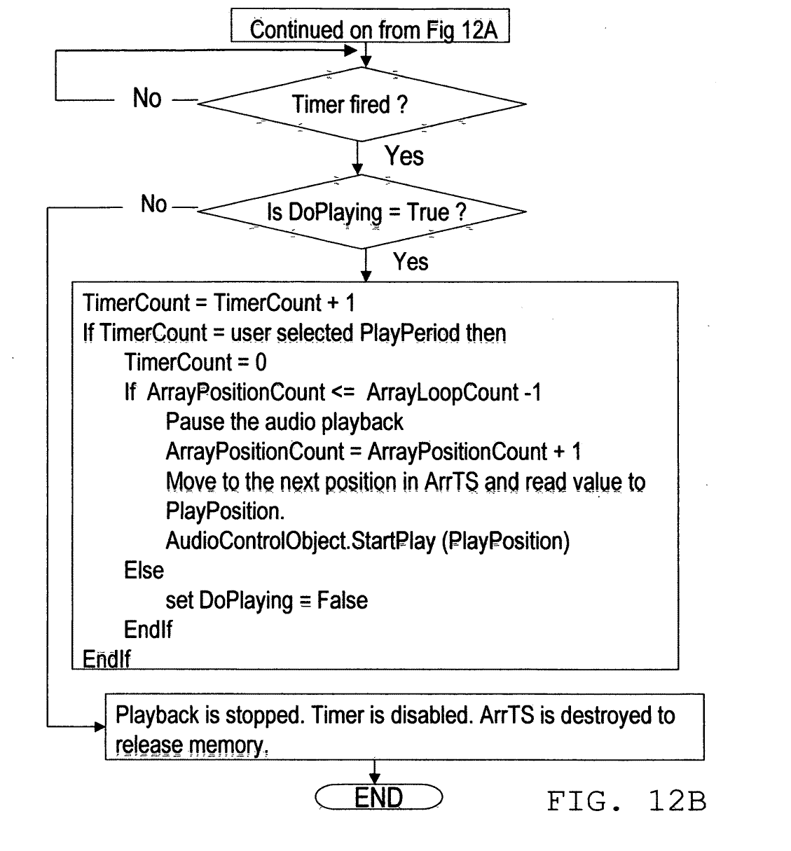

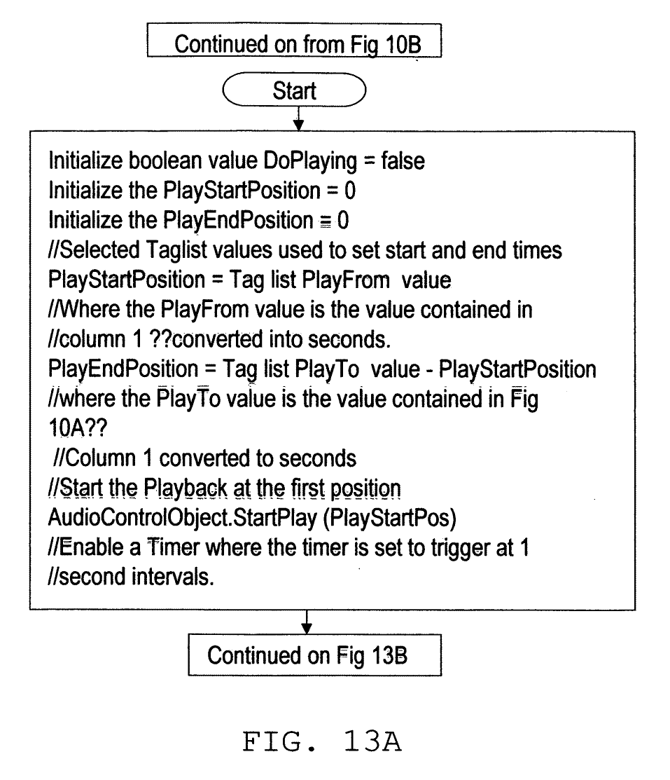

FIG. 9 further illustrates the above where, a graph L. 1 201 represents an audio time-line of a digital audio file where the total play time is divided into 5 minute segments and represents 1 hour of play time. Z 202 represents a period of time that the digital audio file is going to be played and Y 203 represents a single 5 minute interval. The present invention is further understood to those skilled in the art, by referring to FIG. 10 and FIG. 11 for a description of operational flow using this method.

In one scenario audio files of extended length can be played in pieces allowing the user to refresh their memory as to the content of the audio file. I another scenario this method could serve to assist a user in locating a section of audio that is of interest.

In one embodiment of the present invention a selected Tag can be played for a selected period. Referring to FIG. 7, a Playback interface 70 is shown where then user can select an existing audio Tag 78 and a play period 76 (in seconds). Clicking on the Play button 79 will start the audio play with play continuing for the playback period before moving to the next Tag where the next Tags content is equal to the selected Tag.

FIG. 9 further illustrates the above where, a graph L.2 204 represents an audio time-line of a digital audio file where the total play time is divided into 5 minute segments, representing 1 hour of play time and Z 205 represents a period of time that the digital audio file is going to be played. Points A1 206, A2 207 and A3 208 represent an audio files digital assets existing at the 5 minute point, the 15 minute point and at the 35 minute point where the digital assets represented are of equal value. Clicking on the Play button FIG. 7-79 will start the audio playback, starting at A1 206 playing the digital audio file for the selected play period Z and then continuing on to the next A2 207, until each Tag has been played. See FIG. 10 and FIG. 12 for a description of operational flow using this method.

In one scenario a musician choose to play only the sections of the audio file that are of a certain type eg. Vocal harmonies only. In another scenario a lawyer can play only sections of the audio file where certain words or references were made.

In one embodiment of the present invention a user can select a section of audio to be played by choosing a starting Tag and an ending Tag. Referring to FIG. 7, a Playback interface is shown where then user can select an existing audio Tag 80 as a play start time then select another Tag 81 as a play end time. Clicking on the Play button 82 will start the audio playing from the start position until the end position is reached. Play will stop once the play period reaches end position unless the looping option 83 has been selected.

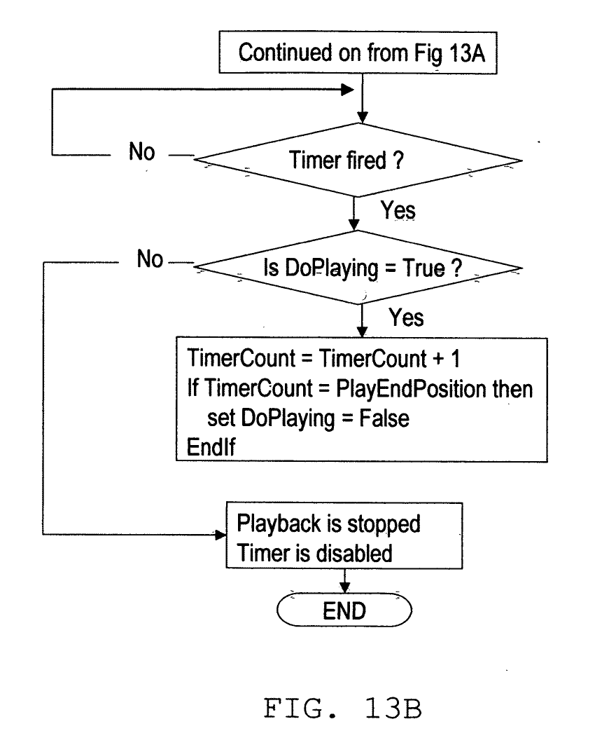

FIG. 9 further illustrates the above where, a graph L.3 301 represents an audio time-line of a digital audio file where the total playtime is divided into 5 minute segments, representing 1 hour of play time. A 302 represents a Tag with a play start time at 5 minutes into the digital audio files play time, and B 304 represents the play end time at 15 minutes into the digital audio files playtime. The present invention is further understood to those skilled in the art, by referring to FIG. 10 and FIG. 13 for a description of operational flow using this method.

In one scenario, this method provides a very efficient method of playing specific sections of audio where audio content can be played to match the textual descriptions, For example a musician might only want to hear the “Dobro” break of one particular section in a piece of music. This could done by selecting the “Dobro” Tag FIG. 780 and the Verse Tag FIG. 781 and then clicking on the Play button FIG. 782. In another scenario, a lawyer would be able to quickly reference and playback a particular sentence uttered by a witness. The method would also be useful for investigating audio events, which may not have been fully understood on first hearing.

From the foregoing, it will be apparent to those skilled in the art that the system and methods of the present invention provide for the creation, review and synchronization of digital media to audio files. Additionally, said methods where User interaction is available may be used individually or in combinations thereof. While the above description contains many specific fea-tures of the invention, these should not be construed as limitations on the scope of the invention, but rather as embodiments thereof. It is understood that these details have been given for the purposes of clarification only. Many other variations are possible. Various changes and modifications if the invention will be apparent, to one having ordinary skill in the art, without departing from the spirit and scope of the invention. Accordingly, the scope of the invention should not be solely determined by the embodiments illustrated.

What is claimed is:

1. A system comprising a Computer (see Glossary), software and user interface where the software is comprised of a database and user interface whereby audio signals can be recorded/played back and stored as a file on a digital storage device

2. An digital media storage system cited by claim 1, including methods where audio file data or a plurality of audio file data is stored within a database table to function as an an audio file reference table.

3. A digital media storage system cited by claim 2, including methods where digital assets are indexed relative to the audio files time-line and stored in a digital assets table within said database and, referenced to the audio file table.

4. A digital media storage system cited by claim 3 , where any form of digital media can be stored in said database.

5. A digital media storage system cited by claim 4 , where a single digital asset record or a plurality of digital asset records can be stored in said database.

6. A digital media storage system cited by claim 5, that includes a User interface providing real-time methods for the creation of plurality of audio records and digital asset records within said database.

7. A User interface recited by claim 6 that includes methods where digital asset records time-line values relative to the audio files time-line, can be negatively adjusted during the recording or playback process.

8. A User interface recited by claim 7 that also includes methods where the adjusted metadata time-line value is calculated as the sum value of a User triggered fixed time-line value plus a User selected negative adjustment value.

9. A User interface recited by claims 6, that includes methods where a plurality of digital asset records containing equivalent digital values, can be used to played back an audio file in ascending sequence according to their values, relative to the audio files playback time-line.

10. A User interface recited by claim 9 that includes a method where a digital asset included as part of the audio playback sequence triggers the audio file to playback at the time-line value contained by the digital asset record.

11. A User interface recited by claim 10, that includes a method where a digital asset record contained in the playback sequence is played for a fixed period of time before moving to the next record in the playback sequence.

12. A User interface recited by claim 9, that includes a method where Users' can move foreward or backward within-in the playback sequence.

13. A User interface recited by claims 6, that includes a method where an audio file can be played back in ascending sequence at equally spaced time intervals relative to audio files time-line

14. A User interface recited by claim 13 that includes a method where an audio file can be played for a fixed period of time, according to the Users selection.

15. A User interface recited by claim 13, that includes a method where Users' can move foreward or backward within-in the playback sequence.

16. The User interface recited by claim 13 a method where the User can select the playback time interval.
